(19) United States
(12) Patent Application Publication
(10) Pub. No.: US 2021/0238009 A1
(43) Pub. Date: Aug. 5, 2021

(54) ELEVATOR CAR WITH MOVING EMERGENCY STOP DEVICE

(71) Applicant: Otis Elevator Company, Farmington, CT (US)

(72) Inventor: Bi Xiong, Châtillon-sur-Loire (FR)

(21) Appl. No.: 16/952,312

(22) Filed: Nov. 19, 2020

(30) Foreign Application Priority Data
Feb. 4, 2020 (EP) 20305097.6

(51) Int. Cl. B66B 5/00; B66B 5/02; B66B 11/02

(52) U.S. Cl. CPC B66B 5/0062; B66B 11/0226; B66B 5/0081; B66B 5/02

(57) ABSTRACT

An elevator car (2) includes a roof (4) and an emergency stop device (6) mounted on the roof (4). The emergency stop device (6) is mounted to move between a first position (8) on the roof (4) during a normal operation mode and a second, different position on the roof (4) during an inspection mode. For example, the emergency stop device (6) is movably mounted to a safety balustrade (12) installed on the roof (4). A safety volume (30) may therefore be positioned to align better with a maintenance area (22) on the roof.

### FOREIGN PRIORITY

This application claims priority to European Patent Application No. 20305097.6, filed Feb. 4, 2020, and all the benefits accruing therefrom under 35 U.S.C. § 119, the contents of which in its entirety are herein incorporated by reference.

### TECHNICAL FIELD

This disclosure relates to an elevator car with a moving emergency stop device.

### BACKGROUND

Elevator safety codes specify a safety volume on top of the roof of an elevator car in which a maintenance person can take refuge in the event of the elevator car moving to the top of the hoistway. Ideally a maintenance person should stand in the safety volume when carrying out maintenance procedures. Since the EN81-20 standard came into force in 2017, the restrictions around the safety volume imply a lot of constraint for where the safety volume is defined on the roof of the car. Often the maintenance area does not easily coincide with the safety volume.

Usually there is an emergency stop button installed on the roof of an elevator car so that a maintenance person has a safety provision (in addition to the safety volume) when accessing the roof for the purposes of carrying out examination, maintenance or repair. Depending on whereabouts a person is standing on the roof, the emergency stop switch may not be easy to reach during a maintenance procedure. Furthermore, it is difficult to place the safety volume to comply with a requirement that the emergency stop button is reachable from the safety volume by a maximum horizontal distance of 300 mm and also reachable from the interior edge of the car door frame by a maximum horizontal distance of 750 mm.

### SUMMARY

According to a first aspect of this disclosure there is provided an elevator car comprising: a roof and an emergency stop device mounted on the roof; wherein the emergency stop device is mounted to move between a first position on the roof during a normal operation mode and a second, different position on the roof during an inspection mode.

According to this disclosure, it is possible to move the emergency stop device to a second position on the roof during an inspection mode, for example the second position corresponding to a maintenance area where a maintenance person stands on the roof while carrying out a maintenance procedure. The maintenance person therefore has freedom and flexibility in positioning the emergency stop device during an inspection mode. As the emergency stop device can be moved to the second position, a safety volume can be defined on the roof relative to the second position (e.g. keeping within a reaching distance of 300 mm) and this helps to align the safety volume with a maintenance area where a person is working in the vicinity of the second position. Having freedom to move the emergency stop device to a second position also means that the maintenance area and/or safety volume can be positioned to avoid interference from any crosshead of a car frame passing across the roof.

In one or more examples, the elevator car comprises a safety volume defined on the roof, and the second position is within a horizontal distance of 300 mm from the safety volume. In at least some examples, the second position is next to or within the safety volume. The safety volume represents a refuge space for a person working on the roof. In at least some examples, the safety volume may be defined by a relevant safety code, such as European Standard EN81-1 (for elevators installed up to 31 Aug. 2017) or European Standard EN81-20 effective from 1 Sep. 2017. For example, the safety volume may be defined by an area of 500×700 mm on the roof.

In examples of the present disclosure, the emergency stop device is any actuatable device (e.g. switch, button, knob or similar) that can be operated to bring the car to an emergency stop. For example, the emergency stop device may be mechanically or electrically connected to an emergency stop brake mounted to the elevator car. For example, the emergency stop device may be mechanically or electrically connected to a blocking member arranged in the hoistway to block movement of a counterweight connected to the car and thereby stop the elevator car from moving any higher in the hoistway.

Although the emergency stop device is movable between different positions, ideally this function is provided while the emergency stop device is mounted to a structure that is permanently installed on the roof. Indeed it may be required by safety code for the emergency stop device to be permanently installed on the roof.

The emergency stop device can be mounted for movement between the first and second positions on the roof in any suitable way. For example, a dedicated track or rail may be installed on the roof. In one or more examples, the elevator car further comprises a safety balustrade installed on the roof, and the emergency stop device is movably mounted to the safety balustrade. Typically a safety balustrade is permanently installed on the roof as another safety feature. The safety balustrade may be installed in a fixed upstanding position, or the safety balustrade may be installed so as to pivot or fold into an upstanding position when required, as is known in the art.

In one or more examples, the emergency stop device is movably mounted to slide along a rail of the safety balustrade, preferably a median rail. In one or more examples, the emergency stop device comprises one or more rollers or guide shoes for mounting to the rail of the safety balustrade.

In one or more examples, in addition or alternatively, the elevator car further comprises one or more position sensors for the emergency stop device. A position sensor may be used to determine whether the emergency stop device is correctly positioned for the normal operation mode and/or the inspection mode. In at least some examples the position sensor comprises a microswitch or Hall Effect sensor.

For example, a first position sensor is arranged to detect when the emergency stop device is present at the first position. Optionally, the first position sensor may be connected to a safety switch such that the safety switch is closed to allow the normal operation mode only when the emergency stop device is present at the first position. In at least some examples, the elevator car comprises a car door frame and the first position is within a horizontal distance of 750 mm from an interior edge of the car door frame. This means that normal operation mode can only be resumed once the emergency stop device has been returned to the first position within reach of the landing doors. Because the emergency stop device can be moved between at least two different positions, in some examples the first position can be closer to the interior edge of the car door frame than in the prior art. Thus, in at least some examples, the first position is within a horizontal distance of 600 mm, 500 mm, 400 mm, 300 mm, 200 mm or 100 mm from an interior edge of the car door frame.

In at least some examples, in addition or alternatively, when the first position sensor detects that the emergency stop device has moved away from the first position (e.g. towards a second position), the safety switch may be opened to activate the inspection mode automatically. This provides a failsafe even if the emergency stop device is not moved all the way to a predetermined second position where a second position sensor is mounted, as described further below.

For example, in addition or alternatively, a second position sensor is mounted at a predetermined second position to detect when the emergency stop device is moved to an inspection position during an inspection mode. Optionally, the second position sensor may be connected to a safety switch such that the safety switch is open to disable the normal operation mode when the emergency stop device is present at the second position. This provides a safety backup in the event that a maintenance person has not already made a manual selection between the normal operation mode and the inspection mode, e.g. using a mode selection switch as described below.

In one or more examples, in addition or alternatively, the elevator car further comprises locking means arranged to lock the emergency stop device in the first position and/or second position. For example, the locking means is a mechanical or electromechanical latch.

In some examples the emergency stop device is a standalone device. In some other examples the emergency stop device is integrated with an inspection control device. This means that the inspection control device can also be moved between different positions, rather than being installed at a fixed position on the roof, and becomes more accessible e.g. before, during and after maintenance procedures. In examples of the present disclosure, the inspection control device may be any device used to control operation of the elevator car at least during an inspection mode. In at least some examples, the inspection control device comprises a mode selection switch for making a selection between the normal operation mode and the inspection mode. The inspection control device may be arranged such that this switch is only operable when the inspection control device is in the first position (e.g. using a position sensor as described above or other means). This means that the inspection control device has to be returned to the first position before the normal operation mode can be activated. As described above, in at least some examples the elevator car comprises a car door frame and the first position is within a horizontal distance of 750 mm from an interior edge of the car door frame. This means that a person can reach from the landing to operate the mode selection switch before/after a maintenance procedure.

In at least some examples, in addition or alternatively, the inspection control device comprises an “up” button and/or a “down” button, or a switch to control up and/or down movement of the elevator car.

In at least some examples, in addition or alternatively, the inspection control device further comprises an electrical junction box. This means that the electrical junction box is not fixed in position on the roof and can be moved with the inspection control device.

In one or more other examples, the elevator car further comprises an electrical junction box installed on the roof, wherein the emergency stop is movably connected to the electrical junction box by a flexible electrical cable. This means that the emergency stop device (optionally integrated with an inspection control device) is movable independently of the electrical junction box.

It will be understood that the second position is any position on the roof that is different to the first position, for example at a greater horizontal distance from an interior edge of the car door frame than the first position. In at least some examples the elevator car comprises a car door frame and the second position is more than a horizontal distance of 750 mm from an interior edge of the car door frame, for example more than 800, 900 or 1000 mm from an interior edge of the car door frame.

### DRAWING DESCRIPTION

Certain preferred examples of this disclosure will now be described, by way of example only, and with reference to the accompanying drawings, in which:

FIGS. 1a and 1b are a top view of an elevator system according to the prior art;

FIG. 2a is a top view of an elevator system according to an example of the present disclosure in a normal operation mode with an emergency stop device in a first position;

FIG. 2b shows the same example in an inspection mode when the emergency stop device has been moved to a second position;

FIG. 2c shows the same example when the emergency stop device has been moved back to the first position;

FIG. 3a is a schematic perspective view of an elevator car according to an example of the present disclosure during a normal operation mode with an emergency stop device in a first position;

FIG. 3b is a schematic perspective view of the elevator car during an inspection mode when the emergency stop device has been moved to a second position; and

FIG. 4 is a front view of an inspection control device including an emergency stop device according to another example.

### DETAILED DESCRIPTION

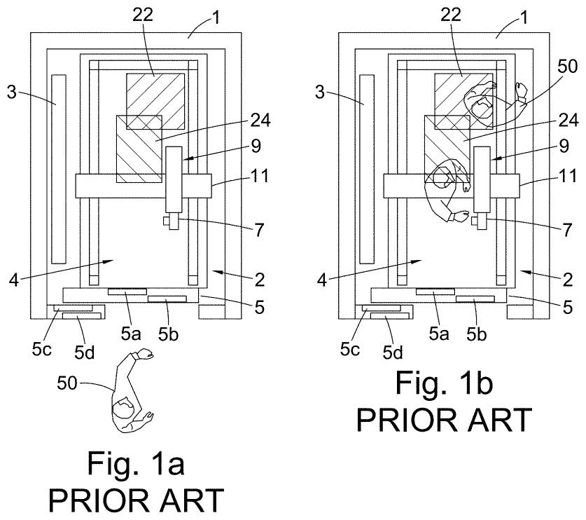

There is seen in FIGS. 1a and 1b a plan view of an elevator system including an elevator car 2 and a counterweight 3 in a hoistway 1. The elevator car 2 has a roof 4 over which there is mounted a crosshead 11 (typically connected to a car frame). When the elevator car 2 is stopped below a landing, the car doors 5a, 5b in a car door frame 5 are kept closed while the landing doors 5c, 5d are opened so that a maintenance person 50 may access the roof 4 as a working platform. Other components of the elevator system have been omitted.

From FIGS. 1a and 1b it should be understood that an elevator car 2 according to the prior art has an emergency stop device 7 mounted in a fixed position on the roof 4 of the elevator car 2. In this example, the emergency stop device 7 is integrated with an inspection box and electrical junction box as a single unit 9. In order for the emergency stop device 7 to be in reach from the car door frame 5, the unit 9 is mounted over a crosshead 11 on the roof 4. A maintenance person 50 can reach the emergency stop device 7 from a landing and stop the elevator car 2 before accessing the roof 4, as seen in FIG. 1a. However, during an inspection mode as seen in FIG. 1b, the maintenance person 50 will typically be standing in a maintenance area 22 that is far from the emergency stop device 7. A safety volume 24 defined on the roof 4 has to keep within a horizontal distance of 300 mm from the emergency stop device 7 and hence does not coincide with the maintenance area 22. A person working in the maintenance area 22 is not in the refuge of the safety volume 24, as seen from FIG. 1b. Furthermore, the safety volume 24 is in interference with the crosshead 11 and this makes it an uncomfortable space for a person to occupy.

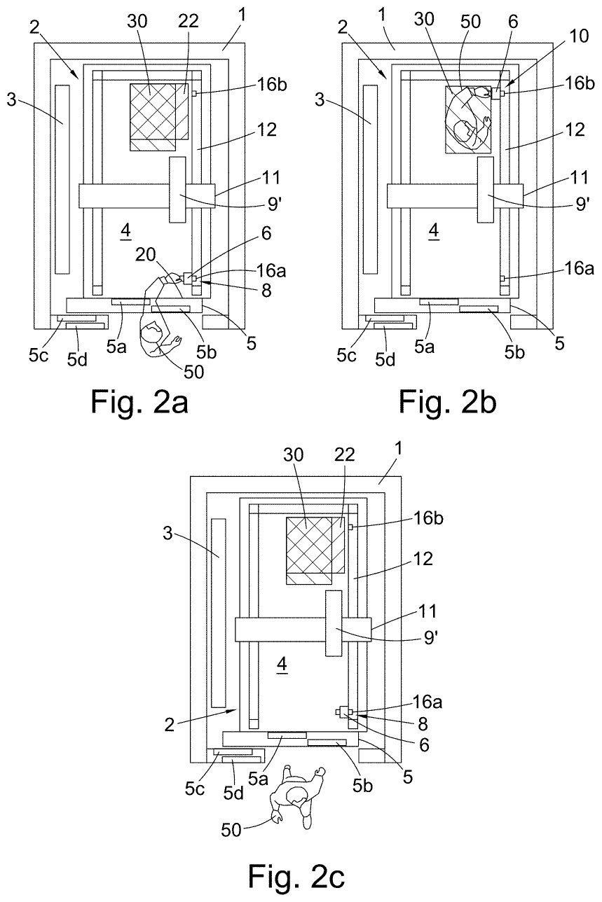

FIGS. 2a-2c show an elevator system including an elevator car 2 according to an example of the present disclosure. As in the prior art, there is seen an elevator car 2 and a counterweight 3 in a hoistway 1. The elevator car 2 has a roof 4 over which there is mounted a crosshead 11 (typically connected to a car frame). When the elevator car 2 is stopped below a landing, the car doors 5a, 5b in a car door frame 5 are kept closed while the landing doors 5c, 5d are opened so that a maintenance person 50 may access the roof 4 as a working platform.

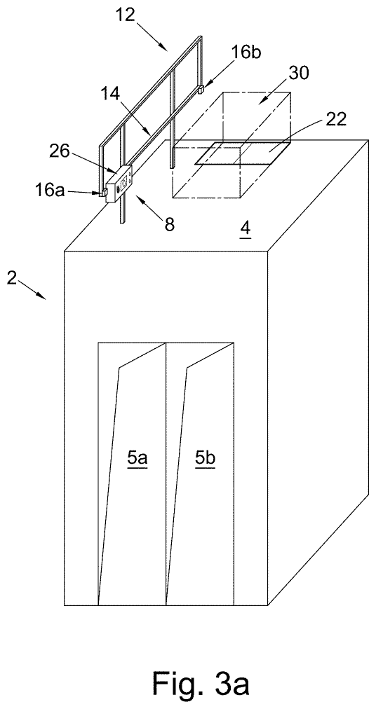

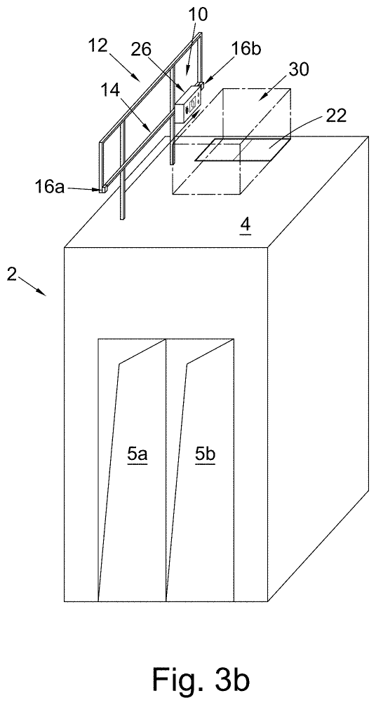

A safety balustrade 12 is installed on the roof 4, in this example around the three open sides of the elevator car 2 so as to prevent a person from falling off the roof 4. A standalone emergency stop device 6 is mounted on the roof 4 so as to be able to move between a first position 8 on the roof 4 during a normal operation mode (FIGS. 2a and 2c) and a second, different position 10 on the roof 4 during an inspection mode (FIG. 2b). In this example, the emergency stop device 6 is movable independently of an inspection control device and electrical junction box 9′ that is mounted over the crosshead 11. The emergency stop device 6 is movably mounted to the safety balustrade 12. As is seen better from FIGS. 3a and 3b, the emergency stop device 6 is movably mounted to slide along a rail 14 of the safety balustrade 12. The emergency stop device 6 can include rollers or guide shoes to facilitate its sliding movement along the rail 14 or other part of the safety balustrade 12.

FIG. 2a shows the normal operation mode with the emergency stop device 6 in the first position 8, at one end of the safety balustrade 12, which is relatively close to an interior edge 20 of the car door frame 5. The emergency stop device 6 is much easier to reach from a landing than in the prior art arrangement of FIG. 1a. A maintenance person 50 easily reaches the emergency stop device 6 to stop the elevator car 2 ready to enter an inspection mode. A safety volume 30 is defined on the roof 4, substantially overlapping with a maintenance area 22. As compared to FIG. 1a, the safety volume 30 is no longer in interference with the crosshead 11.

FIG. 2b shows the inspection mode with the emergency stop device 6 moved to the second position 10, at the opposite end of the safety balustrade 12. It can be seen that a maintenance person 50 working in the maintenance area (not visible) is now automatically in the refuge of the safety volume 30. Furthermore, the maintenance person 50 has freedom to select one or more second positions by sliding the emergency stop device 6 along the safety balustrade 12, depending on where on the roof 4 the maintenance area 22 is positioned or it is desired to stand during maintenance procedures. The maintenance person 50 can select from a number of second positions 10 that are within a horizontal distance of 300 mm from the safety volume 30. However, there is a position sensor 16b mounted at a predetermined second position 10 to detect when the emergency stop device 6 has been moved to this second position 10. The emergency stop device 6 may be locked in this second position 10 during the inspection mode. This position sensor 16b is optionally connected to a safety switch such that the safety switch is open to disable the normal operation mode when the emergency stop device 6 is present at the predetermined second position 10.

FIG. 2c shows the emergency stop device 6 returned to the first position 8 at the end of a maintenance procedure in the inspection mode. It may be necessary to first unlock the emergency stop device 6 from the second position 10 and/or lock the emergency stop device 6 in the first position 8 before normal operation mode can be resumed. As will be described in more detail below, a position sensor 16a is located at the first position 8 to check that the emergency stop device 6 has returned before resuming the normal operation mode after the inspection mode. This position sensor 16a is optionally connected to a safety switch such that the safety switch is closed to allow the normal operation mode only when the emergency stop device 6 is present at the first position 8.

FIGS. 3a and 3b schematically illustrate how the emergency stop device 6 is optionally integrated with an inspection control device 26 in at least some examples, and the inspection control device 26 is movably mounted to slide along a rail 14 of the safety balustrade 12. Although not seen in the Figures, the inspection control device 26 can include rollers or guide shoes to facilitate its sliding movement along the rail 14.

In FIG. 3a the inspection control device 26 is in the first position 8 as detected by a first position sensor 16a installed on the safety balustrade 12. During a normal operation mode, the inspection control device 26 may be locked in the first position 8. In FIG. 3b the inspection control device 26 is in the second position 10 as detected by a second position sensor 16b installed on the safety balustrade 12. During an inspection mode, with the inspection control device 26 in the second position 10, the safety volume 30 is defined so as to be no more than a horizontal distance of 300 mm from the second position 10. This means that the safety volume 30 can now coincide with the maintenance area 22 on the roof 4 that is used during the inspection mode.

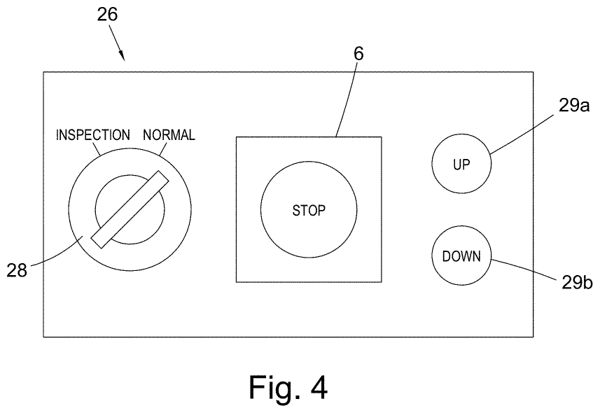

Turning to FIG. 4, an example of the inspection control device 26 is seen in more detail. The inspection control device 26 is an integrated unit including the emergency stop device 6. Furthermore, the inspection control device 26 may optionally include a mode selection switch 28 for making a manual selection between the normal operation mode and the inspection mode. Further optionally, the inspection control device 26 may include one or more other control switches or buttons for use by a maintenance person, such as an UP button 29a and a DOWN button 29b, e.g. for manual raising and lowering of the car (typically at a reduced speed) during the inspection mode.

When initiating a maintenance procedure, a maintenance person may first reach into the hoistway from a landing to operate the inspection control device 26 at the first position 8 seen in FIG. 3a, turning the mode selection switch 28 to manually select the inspection mode. This may act to automatically unlock the inspection control device 26 so that it is movable. Once the inspection mode is active, it is safe for the maintenance person to access the roof of the elevator car. The maintenance person can then move the inspection control device 26, e.g. along a rail of a safety balustrade as described above, or otherwise, to a desired second position, such as the second position 10 seen in FIG. 3b. The maintenance person can stand in the maintenance area 22, within the refuge of the safety volume 30, and the inspection control device 26 is within reach, i.e. the second position 10 can be within a horizontal distance of 300 mm from the safety volume 30.

It will be appreciated by those skilled in the art that the present disclosure has been illustrated by describing one or more specific examples thereof, but is not limited to these aspects; many variations and modifications are possible, within the scope of the accompanying claims.

What is claimed is:

1. An elevator car (2) comprising:
a roof (4) and an emergency stop device (6) mounted on the roof (4);
wherein the emergency stop device (6) is mounted to move between a first position (8) on the roof (4) during a normal operation mode and a second, different position (10) on the roof (4) during an inspection mode.

2. The elevator car of claim 1, further comprising a safety balustrade (12) installed on the roof (4), wherein the emergency stop device (6) is movably mounted to the safety balustrade (12).

3. The elevator car of claim 2, wherein the emergency stop device (6) is movably mounted to slide along a rail (14) of the safety balustrade (12), preferably a median rail.

4. The elevator car of claim 3, wherein the emergency stop device (6) comprises one or more rollers or guide shoes for mounting to the rail (14) of the safety balustrade (12).

5. The elevator car of claim 1, further comprising one or more position sensors (16a, 16b) for the emergency stop device (6).

6. The elevator car of claim 5, wherein a first position sensor (16a) is arranged to detect when the emergency stop device (6) is present at the first position (8).

7. The elevator car of claim 6, wherein the first position sensor (16a) is connected to a safety switch such that the safety switch is closed to allow the normal operation mode only when the emergency stop device (6) is present at the first position (8).

8. The elevator car of claim 5, wherein a second position sensor (16b) is mounted at a predetermined second position (10) to detect when the emergency stop device (6) is moved to an inspection position during an inspection mode.

9. The elevator car of claim 8, wherein the second position sensor (16b) is connected to a safety switch such that the safety switch is open to disable the normal operation mode when the emergency stop device (6) is present at the predetermined second position (10).

10. The elevator car of claim 1, further comprising means for locking the emergency stop device in the first position (16a) and/or second position (16b).

11. The elevator car of claim 1, wherein the emergency stop device (6) is integrated with an inspection control device (26).

12. The elevator car of claim 11, wherein the inspection control device (26) comprises a mode selection switch (28) for making a selection between the normal operation mode and the inspection mode.

13. The elevator car of claim 1, further comprising a car door frame (5) and wherein the first position (8) is within a horizontal distance of 750 mm from an interior edge (20) of the car door frame (5).

14. The elevator car of claim 1, comprising a safety volume (30) defined on the roof (4), wherein the second position (10) is within a horizontal distance of 300 mm from the safety volume (30).
